(19) United States
(12) Patent Application Publication
(10) Pub. No.: US 2007/0296193 A1
(43) Pub. Date: Dec. 27, 2007

(54) Safety Device for a Motor Vehicle

(75) Inventors: Werner Bacher, Sindelfingen (DE); Frank Bertele, Dettenhausen (DE); Dominic Reutter, Ebersbach (DE); Friedhelm Sawinsky, Aidlingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/591,668

(22) PCT Filed: Feb. 22, 2005
(86) PCT No.: PCT/EP05/01810

§ 371 Date: Jun. 14, 2007

(30) Foreign Application Priority Data
Mar. 4, 2004 (DE) 10 2004 010 541.3

(51) Int. Cl. B60R 21/02; G05D 3/00

(52) U.S. Cl. 280/748; 701/45

(57) ABSTRACT

A safety device is provided for a motor vehicle having a driver's seat whose sitting position can be adjusted by a seat adjustment drive, and a steering wheel whose steering wheel position can be adjusted by a steering wheel adjustment drive. A control unit evaluates the data which is relevant for the safety of a driving mode, and actuates the steering wheel adjustment drive with timing such that, before an anticipated accident event occurs, a movement of the steering wheel into an optimum steering wheel position for the driver in terms of safety equipment is initiated as a function of the current sitting position of the driver's seat.

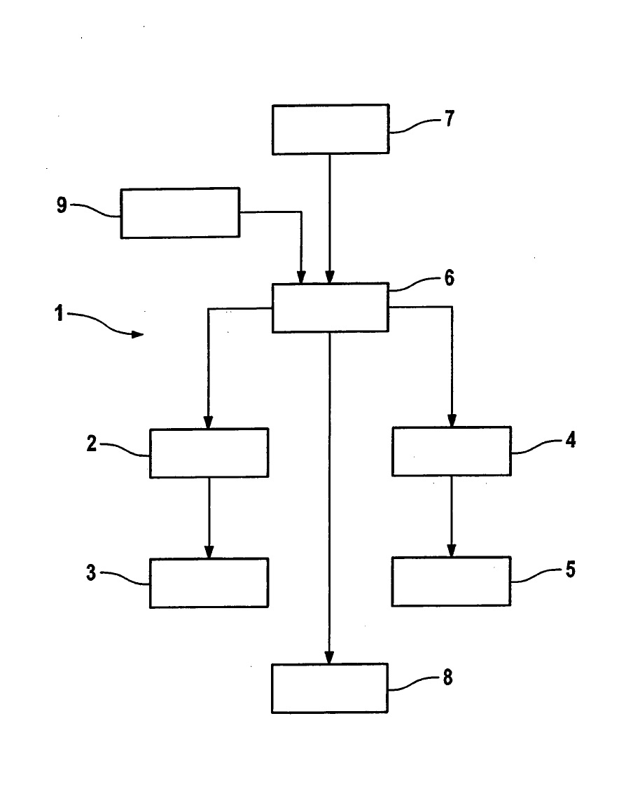

This application is a National Stage of PCT/EP2005/001810, filed Feb. 22, 2005, and claims the priority of DE 10 2004 010 541.3, filed Mar. 4, 2004, the disclosures of which are expressly incorporated by reference herein.

### BACKGROUND AND SUMMARY OF THE INVENTION

The present invention relates to a safety device for a motor vehicle having a driver's seat whose sitting position can be adjusted by a seat adjustment drive.

DE 10.0 29 613 A1 discloses a safety device in which a comfort adjustment of a sitting position and a steering wheel position with electric adjustment means which can be requested by a vehicle occupant is provided. An adjustment speed and the adjustment ranges for the steering wheel and the driver's seat are defined as a function of person-related variables, in particular of the weight and the size of the driver. This allows for the fact that the adjustment margin of relatively large persons is smaller than for correspondingly smaller persons. If the adjustment speed is too high, for example for a relatively large and heavy person, such a person cannot act on the adjustment speed quickly enough and thus will find himself in dangerous trapping positions under certain circumstances. This applies in particular to the driver's seat where the steering wheel projects into the passenger compartment and can constitute an obstacle in terms of safety equipment.

DE 101 21 386 C1 describes a method for actuating a reversible vehicle occupant protection means in a motor vehicle with a sensor system which collects driving state data. Emergency braking operations, oversteering and understeering of the motor vehicle are monitored as driving state data. The vehicle occupant protection means is triggered as a function of such a state. In addition, the direction from which a maximum hazard is to be expected can be determined from the driving state data. The vehicle occupant protection means is actuated in such a way that the protective effect is provided in the direction of maximum hazard.

Furthermore, DE 44 11 184 C2 discloses a restraining belt system for a seat in a vehicle having a seat belt and a belt pretensioner for securing a passenger on the seat. The distance from an object and the corresponding relative speed are determined with a device. The anticipated time until the possible collision between the vehicle and the object can be determined from this. A control unit emits a control signal which increases the force of the belt pretensioner in good time before the possible collision. If a collision can be avoided, the force of the belt pretensioner is reduced again. The controllable belt pretensioner is embodied as a pretensioner which is effective only up to a predefined prestress before the collision, a further belt pretensioner being triggered in order to make the seat belt more taut when the collision is actually detected.

An object of the present invention is to provide a safety device for a motor vehicle having a driver's seat whose sitting position can be adjusted by a seat adjustment drive. The safety device has a degree of vehicle occupant protection which is increased compared to known safety devices.

According to the invention, a control unit is provided in order to evaluate the data which is relevant for the safety of the driving mode and to actuate the steering wheel adjustment drive. The steering wheel adjustment drive is actuated with timing such that, before the anticipated accident event occurs, the movement of the steering wheel into the optimum steering wheel position for the driver in terms of safety equipment is initiated as a function of the current sitting position of the driver's seat.

The safety device for the motor vehicle comprises the driver's seat whose seating position can be adjusted by the seat adjustment drive, and the steering wheel whose steering wheel position can be adjusted by the steering wheel adjustment drive. With the present configuration of the steering wheel adjustment apparatus, the degree of protection for the respective driver is increased as a function of the current sitting position during the accident event which is taking place. An optimum unfolding direction of the airbag can be ensured.

The optimum angle in terms of safety equipment between the steering wheel and upper body of the driver as well as a telescopic direction—which is optimized in terms of safety equipment—of the steering wheel can be adjusted. Furthermore, the driver is prevented from becoming trapped. The time directly before the accident event is already utilized in order to initiate precautionary measures to improve the safety of vehicle occupants. The preventatively acting safety device ensures preventative protection of vehicle occupants.

It is advantageous if the optimum steering wheel position in terms of safety equipment is reached before the occurrence of the accident event. This is ensured by the fact that the optimum setting of the steering wheel position in terms of safety equipment is already present when the accident event occurs. The safety measures are already activated before the actual accident event. For technical reasons, it could, under certain circumstances, be impossible to make an adjustment during the accident event.

In one embodiment of the invention, an optimum steering wheel position in terms of safety equipment is defined for each sitting position of the driver's seat and stored in the control unit. The optimum steering wheel positions in terms of safety equipment are stored in what are referred to as characteristic diagrams and, apart from the dependence on the sitting position, they can also have a dependence on characteristic variables that describe the body of the respective driver, these being for example the size and the weight of the driver.

In a further embodiment, a knee protection device that is related to the driver's seat is actuated by the control unit. The knee protection device is moved here into an optimum knee protection position for the driver in terms of safety equipment as a function of the current sitting position of the driver's seat. The vehicle occupant protection is thereby increased further.

The data which is relevant for the safety of the driving mode may be, in particular, driving state variables. Variables such as speed of the vehicle, yaw accelerations, longitudinal accelerations and transverse accelerations, brake pedal position and accelerator pedal position and the steering angle are used as driving state variables. Furthermore, the status of operator controlled elements such as flashing lights and flashing hazard warning lights as well as the status of sensors and control units which relate to the motor vehicle can be used as the driving state variable.

Alternatively or in addition, the data that is relevant for the safety of the driving mode may be ambient data. Data which is referred to as ambient data is data which is made available by ambient sensors, telematic systems and by communication of the motor vehicle with other motor vehicles and stationary communication systems. Examples of ambient data are information relating to the current location, to the category of road and to the lane on which the driver's own motor vehicle is traveling. Further ambient data is, inter alia, the state of the road, temperature, weather, light conditions and speed, distance, type and size of motor vehicles traveling in front, adjacent, following or oncoming motor vehicles, and of other road users.

It is advantageous if the data that is relevant for the safety of the driving mode is evaluated driver activities. Sensing the driver activity comprises, for example, detecting the movement of the eyes, the viewing direction and also the operator controlled processes of operator controlled elements such as, for example, the steering wheel, gearshift lever and brake pedal. By evaluating a multiplicity of data items which are relevant for safety, where necessary, the coordination unit can be used to determine the correct time for the closing of the sliding roof.

Other objects, advantages and novel features of the present invention will become apparent from the following detailed description of the invention when considered in conjunction with the accompanying drawings.

### BRIEF DESCRIPTION OF THE DRAWING

The sole FIGURE is a block diagram showing a detail of a safety device for a motor vehicle with a driver's seat whose sitting position can be adjusted by a seat adjustment drive, and having a steering wheel whose steering wheel position can be adjusted by a steering wheel adjustment drive.

### DETAILED DESCRIPTION OF THE DRAWING

A safety device designated generally by numeral 1 for a motor vehicle includes a driver's seat 3 whose sitting position can be adjusted by a seat adjustment drive 2, and a steering wheel 5 whose steering wheel position can be adjusted by a steering wheel adjustment drive 4.

Furthermore, a control unit 6 evaluates the data 7 that is relevant for the safety of a driving mode. The data 7 that is relevant for the safety of the driving mode can be driving state variables, ambient data and/or evaluated driver activities. The control unit 6 actuates the steering wheel adjustment drive 4 with timing such that, before the occurrence of an anticipated accident event, a movement of the steering wheel 5 into an optimum steering wheel position for the driver in terms of safety equipment is initiated as a function of the current sitting position of the driver's seat 3. Here, it is advantageous if the optimum steering wheel position for the safety equipment is reached before the accident event occurs. If the accident event does not occur, the steering wheel is moved back into its original steering wheel position.

A steering wheel position which is optimum in terms of safety equipment is defined for each sitting position of the driver's seat 3 and stored in the control unit 6. The sitting position of the driver's seat 3 is defined by a vertical position of the driver's seat 3, by a longitudinal position of the driver's seat 3, by a backrest inclination and/or by a seat cushion inclination. The steering wheel position is defined by a steering wheel column inclination and a steering wheel column longitudinal setting.

In addition, a knee protection device 8 which is related to the driver's seat 3 and/or to a front seat passenger's seat is actuated by the control unit 6. The knee protection device 8 is moved into an optimum knee protection position for the driver in terms of safety equipment as a function of the current sitting position of the driver's seat 3 and/or of the front seat passenger's seat.

Furthermore, a vehicle occupant classification 9 can be provided for the driver's seat 3. As a result, the setting of the optimum steering wheel position in terms of safety equipment and the knee protection position can be carried out additionally as a function of the vehicle occupant classification, in particular as a function of the size and/or the weight of the respective driver.

The safety device 1 according to the present invention for the motor vehicle ensures a high degree of vehicle occupant protection. The steering wheel 5 is already moved into the optimum steering wheel position in terms of safety equipment for each current sitting position before the anticipated accident event. The safety device 1 can be implemented with a low degree of expenditure because the essential components of the safety device 1 are generally already integrated into motor vehicles on a standard basis.

1-9. (canceled)

10: A safety device for a motor vehicle having a driver's seat whose sitting position can be adjusted by a seat adjustment drive and a steering wheel whose steering wheel position can be adjusted by a steering wheel adjustment drive, comprising a control unit that is configured to evaluate data relevant for a driving mode safety and to actuate the steering wheel adjustment drive with timing such that, before an anticipated accident event occurs, a movement of the steering wheel into an optimum steering wheel position for a vehicle driver in terms of safety equipment is initiated as a function of the current sitting position of the driver's seat.

11: The safety device as claimed in claim 10, wherein the optimum steering wheel position in terms of safety equipment is reached before the occurrence of the anticipated accident event.

12: The safety device as claimed in claim 10, wherein an optimum steering wheel position in terms of safety equipment is defined for each sitting position of the driver's seat and is stored in the control unit.

13: The safety device as claimed in claim 10, wherein the sitting position of the driver's seat is defined by at least one of a vertical position of the driver's seat, a longitudinal position of the driver's seat, a backrest inclination and a seat cushion inclination.

14: The safety device as claimed in claim 10, wherein the steering wheel position is defined by a steering wheel column inclination and a steering wheel column longitudinal setting.

15: The safety device as claimed in claim 10, further comprising a knee protection device that is operatively related to the driver's seat and actuateable by the control unit, wherein the knee protection device is movable into an optimum knee protection position for the driver in terms of safety equipment as a function of the current sitting position of the driver's seat.

16: The safety device as claimed in claim 10, wherein a vehicle occupant classification is provided for the driver's seat so that setting of the optimum steering wheel position in terms of safety equipment is able to be carried out additionally as a function of the vehicle occupant classification, including a function of at least one driver size and weight.

17: The safety device as claimed in claim 10, wherein the data that is relevant for the driving mode safety comprises at least one of driving state variables, ambient data and evaluated driver activities.

18: The safety device as claimed in claim 10, wherein the control unit is configured to move the steering wheel back again into an original steering wheel position thereof when the anticipated accident even does not occur.
